(19) United States
(12) Patent Application Publication
(10) Pub. No.: US 2008/0192564 A1
(43) Pub. Date: Aug. 14, 2008

(54) Method For Mixing Dental Impression Pastes, Mixer, And Bowl For Mixing

(76) Inventor: Jean-Luc Jouvin, Batz-sur-mer (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/913,021

(22) PCT Filed: Apr. 14, 2006
(86) PCT No.: PCT/FR2006/000822

§ 371 Date: Oct. 29, 2007

(30) Foreign Application Priority Data
Apr. 28, 2005 (FR) 0504320

(51) Int. Cl. B28C 7/12

(52) U.S. Cl. 366/7; 366/66; 366/19

(57) ABSTRACT

The invention relates to a mixing method for preparing silicon-based dental impression paste while using a planetary centrifugal mixer (1) comprising at least one mixing bowl placed in a bowl carrier (6). The method is characterized by a step in which a certain volume of non-reactive liquid is introduced into the bowl before a mixing step in order to assure a cooling of this paste during the mixing and to prevent the paste from sticking to the walls of the bowl. This liquid is, advantageously, water.

The present invention relates to the field of mixing impression pastes for dental use and in particular silicones for dental use.

Mixing methods for the preparation of impression pastes used in the dental field are well known.

Such methods use, for example, a planetary centrifugal mixer intended to receive at least one bucket containing the impression paste.

Such mixers are known in the art, one being described, for example, in French patent application No. 90/12904 by the present applicant.

Such a mixer includes mainly a mobile double-arm driven in rotation about a main axis, said axis having at the extremity of its free ends means for driving in rotation a bowl carrier with a removable bowl.

This type of mixer has made it possible to improve the quality of the mixing operation, as compared to previous devices. However, it is adapted mostly to the mixing of alginates.

A number of problems arise in the case of mixing silicones such as vinyl-polysiloxanes with addition-reaction reticulation. In a known manner, obtaining a silicone-based-impression paste is obtained by mixing two pasty masses, one of which constitutes the base and the other the catalyst. This mixing is often performed manually. Nevertheless, it is of course advantageous to be able to use the mixer used for the mixing of alginates to mix the silicones automatically. However, the mixer causes more or less important heating. In that case, the hardening and setting of the pastes accelerates with the increase in temperature. Either homogenization of the composition is fully performed and the utilization time of the paste before it hardens is reduced, or the mixing is interrupted before full homogenization of the composition, in order to preserve the utilization time of the composition before it hardens. This result in an unsatisfactory compromise between homogenization quality and utilization time of the composition.

In addition, the silicone tends to adhere to the bowl during mixing. A large portion of the energy of the device is used to help the pasty mass slide at the bottom of the bowl. This energy is lost for the mixing and is transformed into heat.

In addition, the mixing, as presently performed, is particularly noisy.

An objective of the present invention is in particular to solve the above-mentioned problems, in particular in the case of so-called “putty” silicones.

To this effect, the present invention proposes a method for mixing pastes for dental use in a planetary centrifugal mixer comprising at least a mixing bowl, characterized in that it comprises a step of introducing a certain volume of non-reactive liquid into the bowl before a mixing step in order to ensure a cooling of said paste during mixing and prevent said paste from sticking to the walls of said bowl.

Advantageously, said liquid is water.

Silicones, and in particular silicones of the “putty” type, are hydrophobic products and, as a consequence, there is no risk of mixing with water. On the contrary, the paste remains well agglomerated. The water ensures a good cooling of the paste in the course of being mixed, and in addition, it ensures that the paste does not stick to the walls of the bowl during mixing.

According to another aspect of the present invention, a planetary centrifugal mixer is proposed for implementing the above-mentioned method, of the type intended to receive at least one removable bowl for the preparation of mixtures used in the dental field, of the type including a mobile double-arm driven in rotation about a main axis, the ends of said double arm being equipped with bowls carriers mounted mobile in rotation about secondary axes inclined one toward the other and forming with the main axis an angle comprised between about 40 and 60 degrees, characterized in that it comprises a central axis coaxial with said main axis and terminated by a central pinion meshing with two satellite pinions, each of said satellite pinions having an axis inclined parallel to the axis of the corresponding bowl carrier and driving the latter by means of a belt.

Advantageously, said centrifugal mixer has a liquid distribution device adapted to distribute said non-reactive liquid volume.

According to another aspect of the invention, a removable bowl for planetary centrifugal mixer is proposed for implementing the above-mentioned method, said planetary centrifugal mixer comprising a mobile double-arm whose ends are equipped with rotatable bowl carriers, each of said bowl carriers comprises a cylindrical wall having a circular cross-section, characterized in that said bowl is a receptacle of cylindrical shape having an oval or elliptical cross-section and the inner surface of said bowl carrier is provided with a number of ridges whose extremities extend according to a cylindrical surface having an oval or elliptical cross-section corresponding to the shape of said bowl.

Advantageously, said bowl is provided on its outer surface with protruding elements defining between them grooves, each of said grooves being adapted to receive one of said ridges of said bowl carrier.

According to another aspect of the present invention, said bowl carrier comprising a central rod having a circular cross-section and extending along its rotation axis, and said bowl having a central column extending axially and hollowed and opened toward the bottom so as to form a hub adapted to receive said rod, said column has an elongated shape along the long dimension of the bowl.

Advantageously, said central column has, in its lower portion, a rectangular outer cross-section with rounded, oval, or ellipsoidal ends, then, in an upper portion, it narrows until a cylindrical end having a diameter corresponding to a circular lid opening, then conical.

Advantageously, said central column ends with a cylindrical portion topped by a conical end adapted to pass through a central orifice provided at the center of a removable lid adapted to close said bowl, said cylindrical portion having a diameter equal to that of the orifice.

Advantageously, said bowl has, in the area of its upper portion, an annular flange adapted to be fitted into the cylindrical flange having a circular section of a removable lid adapted to close said bowl.

According to another aspect of the present invention, a removable bowl for planetary centrifugal mixer is proposed, characterized in that said bowl is made in a low density metallic alloy such as aluminum or titanium and has a central hub having a circular cross-section.

Advantageously, the inner walls have an anti-adhesion coating such as PTFE (Teflon).

The present invention is advantageously applied to the least fluid silicones, such as heavy silicone or “Putty.” More generally, it can be applied to all dental impression materials which are from the start in the form of hydrophobic pastes.

The invention will be better understood by reading the following description in reference to the annexed drawings in which:

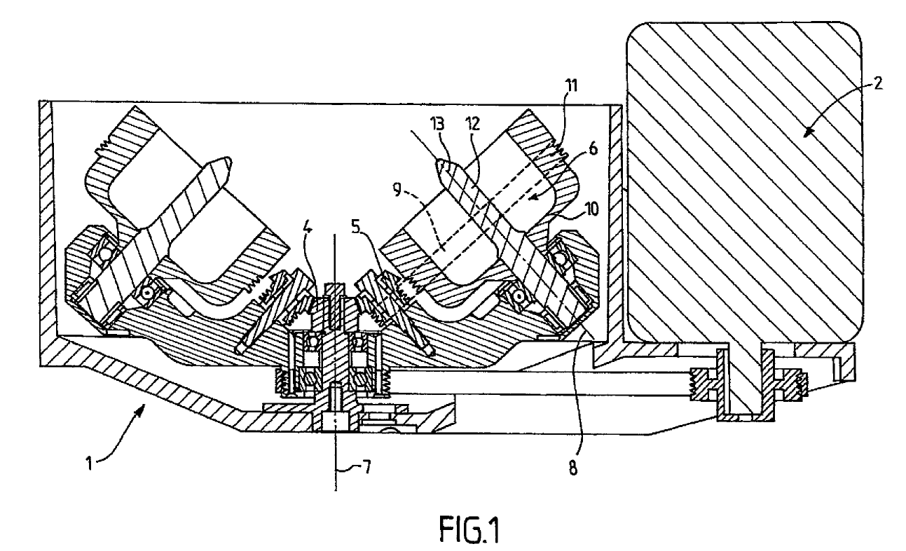

FIG. 1 shows a schematic cross-section view of the mobile parts of a mixer without the bowls according to the invention;

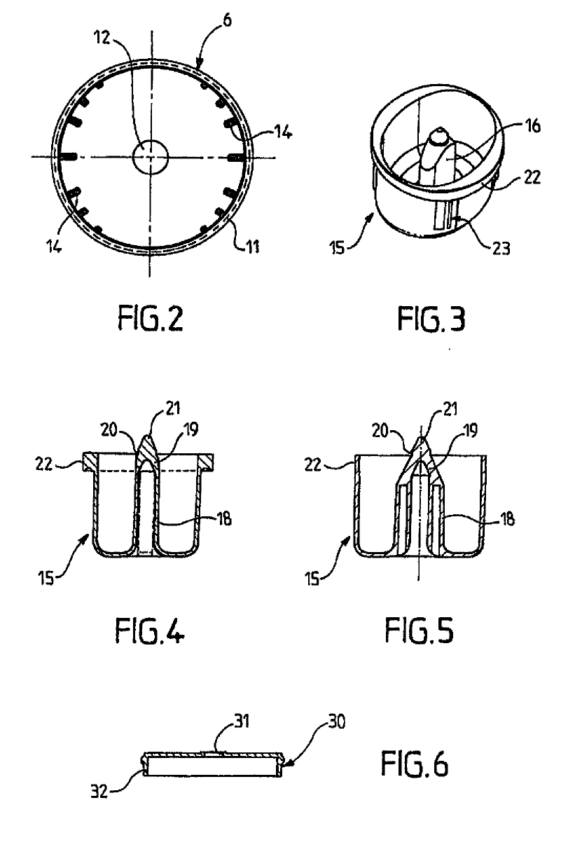

FIG. 2 shows a transverse cross-section view of a bowl carrier of the mixer of FIG. 1;

FIG. 3 shows a perspective view at a smaller scale of a removable bowl for the mixer of FIG. 1;

FIG. 4 shows a longitudinal cross-section view of the bowl of FIG. 3 according to a small direction of the bowl;

FIG. 5 shows a longitudinal cross-section view of the bowl of FIG. 3 according to a large direction of the bowl; and

FIG. 6 shows a lid for the bowl of FIGS. 3 and 5.

FIG. 1 shows a cross-section view of the mobile parts of the mixer according to the invention.

A mixer comprises a double arm 1 mobile in rotation about a main axis 7. A motor 2 drives the double arm 1 by means of a belt engaged with the outer surface of a cylinder coaxial with the main axis and integral with the double arm 1. A shaft passes trough this cylinder, this shaft ending with a central pinion 4 meshing with two satellite pinions 5 mounted on one and the other arms of the double arm 1. The satellite pinions 5 have axes inclined one toward the other according to a same angle, advantageously comprised between 40 and 60 degrees. The arm carrying the central pinion remaining fixed, the rotation of the double-arm drives the satellite pinions 5 in rotation.

The ends of the double arm are equipped with bowl carriers 6 mounted mobile in rotation about secondary axes 8 inclined one toward the other and parallel to the axes of the corresponding satellite pinions 5.

The double arm 1 is different from the device described in French patent No. 90/12904 by the present applicant, in particular because a large number of transmissions by pinions are replaced by transmissions by belts. It has already been described that the arm is driven by the motor 2 by means of a belt. In addition, each of the lateral pinions drives the bowl carrier by means of a belt 9 engaged, on the one hand, with a cylindrical portion extending the pinion toward the bottom, and on the other hand, with the outer surface of a cylindrical wall 11 having a circular cross-section of the bowl carrier. The surfaces of the cylindrical portions that receive the belt 8 are provided with radial grooves that make it possible to ensure a good adhesion of the belt to said cylindrical portions. The belts are preferably “Poly V” belts.

The use of belts instead of transmission gears make it possible to mix more quickly and with less noise. Further, another advantage of this solution is that it slows down more easily when the motor stops, which makes it possible to shorten the mixing time.

The rotation speed of the device can go up to 2750 rpm, which enables a good mixing of the silicone.

Each of the bowl carriers 6 comprises a bottom 10 whose periphery is extended toward the top by a cylindrical wall having a circular cross-section 11, and from the center extends toward the top a rod 12 having a circular cross-section and ending with a conical extremity 13.

FIG. 2 shows a transverse cross-section view of the bowl carrier 6. On the inner surface of the cylindrical wall 11 of this bowl carrier are provided ridges 14 extending parallel to the axis 8 over a same height, starting from the bottom of the bowl carrier. In the example shown, there are 14 ridges disposed symmetrically. Each of these ridges extends radially over a given length, the lengths of each ridge being different so that the ends of these ridges extend according to a cylindrical surface having an oval or elliptical cross-section corresponding to the shape of a removable bowl intended to be positioned in the bowl carrier 6. In the example shown, there are two diametrically opposed ridges having the largest size, three ridges having progressively reduced sizes being disposed on either sides of each of these ridges having the largest size.

Advantageously, the bowl carriers are obtained by molding a plastic material, for example, polyacetal.

FIGS. 3 to 5 show at a smaller scale the bowl 15 intended to be positioned in the bowl carrier 6.

The bowl 15 is made up of a receptacle of cylindrical shape having an oval or elliptical cross-section, from the bottom of which rises a central column 16 forming a hub adapted to receive the rod 12 of the bowl carrier 6. This column 16, extending axially, is thus hollowed and opened toward the bottom so as to define an inner housing having a cylindrical inner diameter adapted to receive the rod 12. The column 16 has an elongated shape along the long dimension of the bowl. In other words, it has a dimension much larger than that of the rod 12 in the direction in which the bowl extends. More precisely, in the embodiment shown, the column 16 is made up of a lower portion 18 having a rectangular outer cross-section with rounded, oval, or ellipsoidal ends, an intermediate portion 19 that narrows in the plane of the long axis of the bowl, and an upper portion made up of a cylindrical portion 20, then a conical portion 21. The cylindrical portion 20 has a circular cross-section whose diameter corresponds to a circular opening 31 of a removable lid 30 adapted to close the bowl 15.

The bowl 15 has, in the area of its upper end, an annular flange 22 adapted to fit into a cylindrical flange having a circular cross-section 32 of the lid 30. As mentioned above, the lid 30 is provided at its center with an orifice 31 in which the upper portion of the column 16 is adapted to be fitted. This double fitting makes it possible to ensure a good hold on the bowl during mixing.

The bowl 15 is provided on its outer surface with protruding elements 23 extending parallel to the axis of the bowl from the bottom of the annular flange 22 over a length corresponding to the height of the ridges 14. These protruding elements are grouped two by two so as to define between them grooves, each of these grooves being adapted to receive a ridge of the bowl carrier when the bowl is positioned in the bowl carrier. Each of the protruding elements thus comprises a right side forming a wall of the groove and a curved side forming a ramp making it possible to guide the groove into aligning with the corresponding protrusion during insertion of the bowl into the bowl carrier.

In the example shown, four grooves are thus disposed around the bowl 15. these grooves are intended to cooperate with four ridges of the bowl carrier. The elliptical or oval shape of the bowl as well as the ramps provided on the protruding elements cooperate to ensure automatic alignment of the grooves and the corresponding ridges during installation of the bowl.

This solution ensures that the bowl is set into the bowl carrier perfectly and quickly, and it avoids a deformation of the bowl carrier when the latter is subjected to important forces.

Before the mixing operation, a certain volume of water is poured into the bowl in which the mixing operation will be performed before introduction of the pasty masses constituting the base and the catalyst. For example, for the doses of pastes usually used, the volume of water is approximately 15 ml. However, this volume can be varied according to the cooling needs.

During mixing, the water does not participate in the reaction but, on the one hand, it performs the cooling of the paste, and on the other hand, it prevents the paste from sticking to the walls of the bowl.

This method is made possible by the fact that there is no risk of mixing with the water given that silicones, an in particular the “putty” silicones, are hydrophobic products.

This mixing method makes it possible, on the one hand, to solve the problem of the unsatisfactory compromise between the homogenization quality and the utilization time of the composition, and on the other hand, to reduce considerably the mixing time. At the end of the operation, the water is thrown away and the silicone is easily extracted from the bowl using a spatula, since it practically does not stick to the walls.

The water can be introduced into the bowl by means of a jet device commonly used in the dental field to wet the powder in the case of alginates. The jets come from a group of nozzles integral with the mixer base, which further includes a housing for positioning the bowl during introduction of the water. Supply to the nozzles is performed by any means making it possible to dose the amount of liquid introduced into the bowl.

Advantageously, the bowls described are obtained by molding a plastic material.

According to a variant not shown of the present invention, a removable bowl is proposed made in a low density metallic alloy such as aluminum or titanium and whose internal walls are covered with a non-adhesive coating such as PTFE (Teflon).

The invention is described above through non-limitative examples.

1. Mixing method for the preparation of dental impression paste in a planetary centrifugal mixer comprising at least one mixing bowl, which comprises a step of introducing a certain volume of non-reactive liquid into the bowl before a mixing step in order to ensure cooling of said paste during mixing and prevent said paste from sticking to the walls of said bowl.

2. Mixing method according to claim 1, wherein said liquid is water.

3. Planetary centrifugal mixer for implementing the method according to claim 1, of the type having a mobile double-arm driven in rotation about a main axis, the ends of said double arm being equipped with bowl carriers rotatably mounted about secondary axes inclined one toward the other and forming with the main axis an angle comprised between about 40 to 60 degrees, which comprises a central shaft coaxial with said main shaft and terminated by a central pinion meshing with two satellite pinions, each of said satellite pinions having an axis inclined parallel to the axis of the corresponding bowl carrier and driving the latter by means of a belt.

4. Mixer according to claim 3, which has a liquid distribution device adapted to distribute said non-reactive liquid volume.

5. Bowl carrier and mixing bowl for implementing the method according to claim 1, said bowl being of the removable type, for a planetary centrifugal mixer comprising a mobile double-arm whose ends are equipped with rotatable bowl carriers, each of said bowl carriers comprising a cylindrical wall having a circular cross-section, wherein said bowl is a receptacle of cylindrical shape having an oval or elliptical cross-section and the inner surface of said cylindrical wall of said bowl carrier is provided with a certain number of radial ridges whose ends extend according to a cylindrical surface having an oval or elliptical cross-section corresponding to the shape of said bowl.

6. Mixing bowl according to claim 5, which is provided on its outer surface with protruding elements defining between them grooves, each of said grooves being adapted to receive one of said ridges of the bowl carrier.

7. Bowl according to claim 5, wherein said bowl carrier comprising a central rod having a circular cross-section extending along its rotation axis and said bowl having a central column extending axially hollowed and opened toward the bottom so as to form a hub adapted to receive said rod, said column has an elongated shape along the long dimension of the bowl.

8. Bowl according to claim 7, wherein at least one portion of said central column has a rectangular outer cross-section with rounded, oval, or ellipsoidal ends.

9. Bowl according to claim 7, wherein said central column ends with a cylindrical portion topped by a conical end adapted to pass through a central orifice provided at the center of a removable lid adapted to close said bowl, said cylindrical portion having a diameter equal to that of the orifice.

10. Bowl according to claim 5, which has, in the area of its upper portion, an annular flange adapted to fit into the cylindrical flange having a circular cross-section of a removable lid adapted to close said bowl.

11. Planetary centrifugal mixer for implementing the method according to claim 2, of the type having a mobile double-arm driven in rotation about a main axis, the ends of said double arm being equipped with bowl carriers rotatably mounted about secondary axes inclined one toward the other and forming with the main axis an angle comprised between about 40 to 60 degrees, which comprises a central shaft coaxial with said main shaft and terminated by a central pinion meshing with two satellite pinions, each of said satellite pinions having an axis inclined parallel to the axis of the corresponding bowl carrier and driving the latter by means of a belt.

12. Mixer according to claim 11, which has a liquid distribution device adapted to distribute said non-reactive liquid volume.

13. Bowl carrier and mixing bowl for implementing the method according to claim 2, said bowl being of the removable type, for a planetary centrifugal mixer comprising a mobile double-arm whose ends are equipped with rotatable bowl carriers, each of said bowl carriers comprising a cylindrical wall having a circular cross-section, wherein said bowl is a receptacle of cylindrical shape having an oval or elliptical cross-section and the inner surface of said cylindrical wall of said bowl carrier is provided with a certain number of radial ridges whose ends extend according to a cylindrical surface having an oval or elliptical cross-section corresponding to the shape of said bowl.

14. Mixing bowl according to claim 13, which is provided on its outer surface with protruding elements defining between them grooves each of said grooves being adapted to receive one of said ridges of the bowl carrier.

15. Bowl according to claim 6, wherein said bowl carrier comprising a central rod having a circular cross-section extending along its rotation axis and said bowl having a central column extending axially hollowed and opened toward the bottom so as to form a hub adapted to receive said rod, said column has an elongated shape along the long dimension of the bowl.

16. Bowl according to claim 14, wherein said bowl carrier comprising a central rod having a circular cross-section extending along its rotation axis and said bowl having a central column extending axially hollowed and opened toward the bottom so as to form a hub adapted to receive said rod, said column has an elongated shape along the long dimension of the bowl.

17. Bowl according to claim 15, wherein at least one portion of said central column has a rectangular outer cross-section with rounded, oval, or ellipsoidal ends.

18. Bowl according to claim 16, wherein at least one portion of said central column has a rectangular outer cross-section with rounded, oval, or ellipsoidal ends.

19. Bowl according to claim 8, wherein said central column ends with a cylindrical portion topped by a conical end adapted to pass through a central orifice provided at the center of a removable lid adapted to close said bowl, said cylindrical portion having a diameter equal to that of the orifice.
